(19) United States
(12) Patent Application Publication
(10) Pub. No.: US 2018/0239442 A1
(43) Pub. Date: Aug. 23, 2018

(54) INFORMATION PROCESSING APPARATUS, INFORMATION PROCESSING METHOD, AND PROGRAM

(71) Applicant: SONY CORPORATION, TOKYO (JP)

(72) Inventor: TAKURO NODA, TOKYO (JP)

(21) Appl. No.: 15/554,817

(22) PCT Filed: Dec. 7, 2015
(86) PCT No.: PCT/JP2015/084328

§ 371 Date: Aug. 31, 2017

(30) Foreign Application Priority Data
Mar. 17, 2015 (JP) 2015-053849

(51) Int. Cl. G06F 3/038; G06F 3/01

(52) U.S. Cl. CPC G06F 3/038; G06F 2203/0381; G06F 3/013

(57) ABSTRACT

[Object] To provide an information processing apparatus, an information processing method, and a program which can improve convenience relating to an gaze input technology.

[Solution] Provided is an information processing apparatus including: a storage control unit configured to acquire, from a storage unit, a history of information indicating correspondence relationship between a position of a gazing point of a user and a position of an indicator indicating an operation position operated by the user; a detecting unit configured to detect the position of the gazing point of the user; and a display control unit configured to control a display position of the indicator so that the indicator is displayed at a position corresponding to the position of the gazing point at present detected by the detecting unit on the basis of the history of the information indicating the correspondence relationship acquired by the storage control unit.

### TECHNICAL FIELD

The present disclosure relates to an information processing apparatus, an information processing method, and a program.

### BACKGROUND ART

In recent years, in accordance with diversification and increase of information processing apparatuses, a technology relating to user interface for allowing more efficient operation of an information processing apparatus has been actively developed.

As one example of such a technology, the following Patent Literature 1 discloses displaying a pointer in each of a plurality of displays in a multi-display environment, and appropriately selecting a pointer to be used by a user in accordance with a use state of the user.

### CITATION LIST

### Patent Literature

Patent Literature 1: JP 2009-223494A

### DISCLOSURE OF INVENTION

### Technical Problem

As one of technologies relating to user interface which has received attention in recent years, there is an gaze input technology. The gaze input technology is a technology of tracking a direction or movement of the line of sight of a user and reflecting the tracking result on movement, or the like, of an indicator such as a pointer and focus. The gaze input technology is convenient because the line of sight of the user can be directly reflected on input. Meanwhile, the gaze input technology is inconvenient because the indicator also follows movement of the line of sight which is not intended to be used for moving the indicator, and, the position of the indicator can be displaced from the original position when the line of sight is moved once and returned. The above-described Patent Literature 1 nowhere discloses a technology for resolving the above-described inconvenience.

Therefore, the present disclosure proposes new and improved information processing apparatus, information processing method, and program which can improve convenience relating to an gaze input technology.

### Solution to Problem

According to the present disclosure, there is provided an information processing apparatus including: a storage control unit configured to acquire, from a storage unit, a history of information indicating correspondence relationship between a position of a gazing point of a user and a position of an indicator indicating an operation position operated by the user; a detecting unit configured to detect the position of the gazing point of the user; and a display control unit configured to control a display position of the indicator so that the indicator is displayed at a position corresponding to the position of the gazing point at present detected by the detecting unit on the basis of the history of the information indicating the correspondence relationship acquired by the storage control unit.

Further, according to the present disclosure, there is provided an information processing method executed by a processor, the method including: acquiring, from a storage unit, a history of information indicating correspondence relationship between a position of a gazing point of a user and a position of an indicator indicating an operation position operated by the user; detecting the position of the gazing point of the user; and controlling a display position of the indicator so that the indicator is displayed at a position corresponding to the detected position of the gazing point at present on the basis of the acquired history of the information indicating the correspondence relationship.

Further, according to the present disclosure, there is provided a program causing a computer to function as: a storage control unit configured to acquire, from a storage unit, a history of information indicating correspondence relationship between a position of a gazing point of a user and a position of an indicator indicating an operation position operated by the user; a detecting unit configured to detect the position of the gazing point of the user; and a display control unit configured to control a display position of the indicator so that the indicator is displayed at a position corresponding to the position of the gazing point at present detected by the detecting unit on the basis of the history of the information indicating the correspondence relationship acquired by the storage control unit.

### Advantageous Effects of Invention

As described above, according to the present disclosure, it is possible to improve convenience relating to an gaze input technology. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram for explaining outline of an information processing system according to the present embodiment.

FIG. 2 is a block diagram illustrating an example of a logical configuration of the information processing apparatus according to the present embodiment.

FIG. 3 is a diagram for explaining a correspondence relationship information storage function of the information processing apparatus according to the present embodiment.

FIG. 4 is a diagram for explaining a display control function using a history of correspondence relationship information of the information processing apparatus according to the present embodiment.

FIG. 5 is a diagram illustrating an example of a map for calibration relating to detection of the line of sight.

FIG. 6 is a flowchart illustrating an example of flow of indicator display position control processing executed at the information processing apparatus according to the present embodiment.

FIG. 7 is a block diagram illustrating an example of a hardware configuration of the information processing apparatus according to the present embodiment.

### MODE(S) FOR CARRYING OUT THE INVENTION

Hereinafter, a preferred embodiment of the present disclosure will be described in detail with reference to the appended drawings. In this specification and the appended drawings, structural elements that have substantially the same function and structure are denoted with the same reference numerals, and repeated explanation of these structural elements is omitted.

Note that description will be provided in the following order.

### 1. Introduction

1.1. Overall configuration
1.2. Technical problem
2. Configuration example
3. Technical characteristics
3.1. Operation information acquisition function
3.2. Multimodal interface function
3.3. Input restriction function
3.4. Correspondence relationship information storage function
3.5. Display control function using history of correspondence relationship information
3.6. Calibration function
4. Operation processing example
5. Hardware configuration example

### 6. Conclusion

### 1. INTRODUCTION

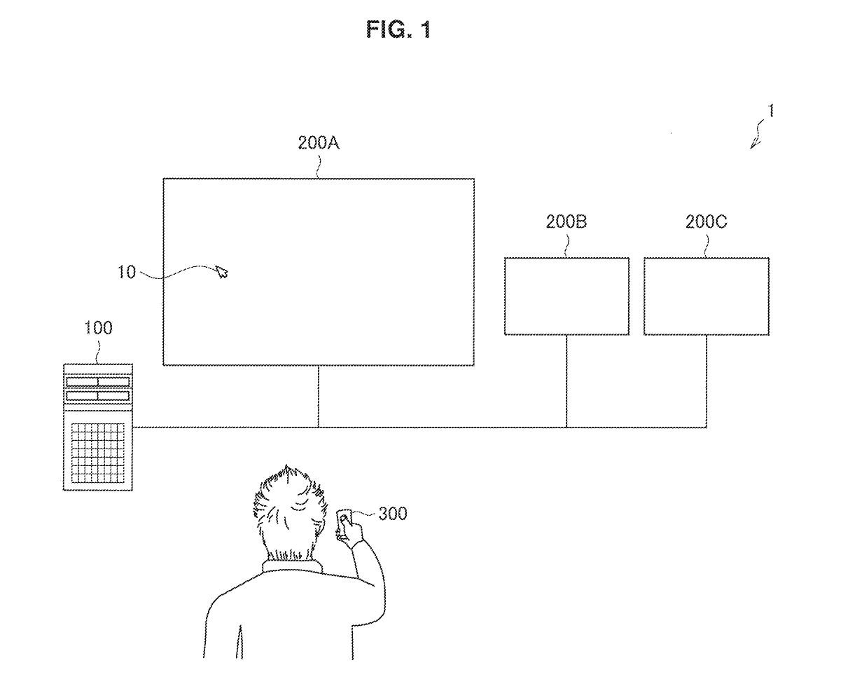

Outline of an information processing apparatus according to an embodiment of the present disclosure will be described first with reference to FIG. 1.

### 1.1. Overall Configuration

FIG. 1 is a diagram for explaining outline of an information processing system 1 according to the present embodiment. As illustrated in FIG. 1, the information processing system 1 includes an information processing apparatus 100 and a display apparatus 200. Further, the information processing system 1 may include an operating apparatus 300. In the example illustrated in FIG. 1, a user holds the operating apparatus 300 and operates an indicator 10 (pointer) displayed at the display apparatus 200A.

The operating apparatus 300 is an apparatus which accepts operation performed by the user. The operating apparatus 300 illustrated in FIG. 1 is a gyro mouse. The gyro mouse 300 has an inertial sensor such as an acceleration sensor and a gyro sensor inside and can reflect inclination, acceleration, or the like, on a position and movement of the indicator 10. The operating apparatus 300 may be implemented with various apparatuses such as a mouse, a keyboard and a touch pad.

The display apparatus 200 is an apparatus which displays information. The display apparatuses 200A, 200B and 200C illustrated in FIG. 1 are displays. The display apparatus 200 can display arbitrary content such as an image, video, application, text and web content. Further, the display apparatus 200 displays the indicator 10 such as a pointer, focus and a cursor, which indicates an operation position. The display apparatus 200 communicates with the information processing apparatus 100 in a wired or wireless manner and displays the indicator 10 on the basis of control by the information processing apparatus 100.

The information processing apparatus 100 is an apparatus which controls a display position of the indicator displayed at the display apparatus 200. The information processing apparatus 100 illustrated in FIG. 1 is a personal computer (PC). For example, the information processing apparatus 100 controls the display position of the indicator 10 on the basis of information acquired by the operating apparatus 300. The information processing apparatus 100 may, for example, have a sensor for detecting the line of sight or voice of the user and may accept operation of the indicator using voice input or gaze input.

Note that the information processing system 1 can take various kinds of forms in addition to the example illustrated in FIG. 1. For example, the information processing apparatus 100 and the display apparatus 200 may be implemented with a head mounted display (HMD). In this case, for example, gaze input can be realized by the line of sight being detected by a camera directed to both eyes of the user who wears the HIVID.

### 1.2. Technical Problem

It can be said that gaze input is effective compared to other modals in a situation where the whole screen does not fall within view because a screen is large as the display apparatus 200A or there exist a plurality of screens as the display apparatuses 200B and 200C. This is because an input range of gaze input is wide, and the user rarely loses sight of the indicator because the indicator follows the line of sight. Further, in the case where an amount of movement of the indicator is large, while, for example, it is necessary to perform operation of moving a mouse back and forth many times if input is performed using the mouse, such troublesome operation is not required with gaze input. Concerning this, while the above-described troublesome operation is alleviated by increasing the amount of movement of the indicator with respect to an amount of movement of the mouse, pointing accuracy degrades as an adverse effect.

However, as described above, the gaze input technology is inconvenient because the indicator also follows movement of the line of sight which is not intended to be used for moving the indicator, and the position of the indicator can be displaced from the original position when the line of sight is moved once and returned. For example, such inconvenience becomes obvious in the case where a plurality of windows are displayed alongside, or during work of selecting one file from a plurality of arranged files. Therefore, in view of the above-described circumstances, an information processing apparatus 100 according to an embodiment of the present disclosure has been created. The information processing apparatus 100 according to the present embodiment can alleviate the above-described inconvenience by correcting a display position of an indicator on the basis of a history of information indicating correspondence relationship between a position of a gazing point and a position of the indicator.

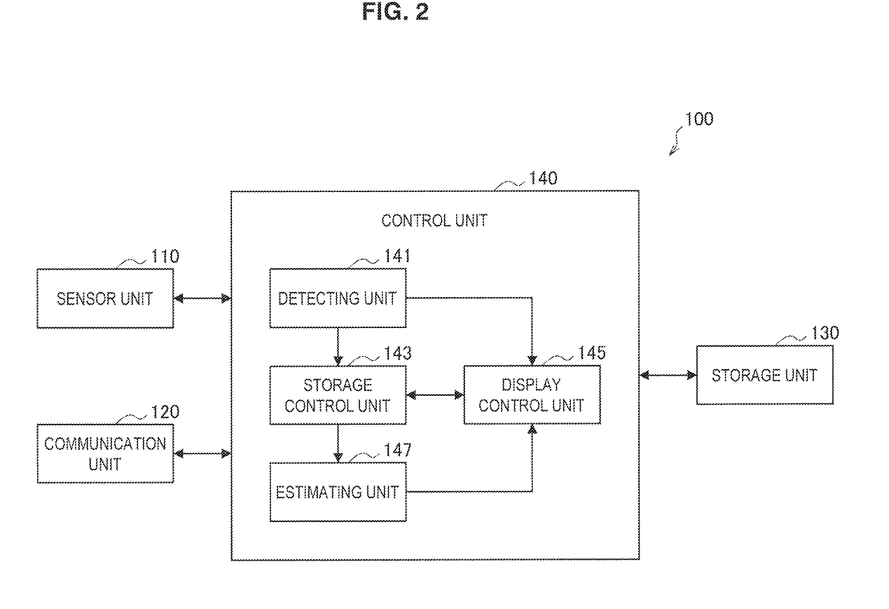

The outline of the information processing apparatus 100 according to the present embodiment has been described above. A configuration example of the information processing apparatus 100 according to the present embodiment will be described next with reference to FIG. 2.

### 2. CONFIGURATION EXAMPLE

FIG. 2 is a block diagram illustrating an example of a logical configuration of the information processing apparatus 100 according to the present embodiment. As illustrated in FIG. 2, the information processing apparatus 100 includes a sensor unit 110, a communication unit 120, a storage unit 130 and a control unit 140.

The sensor unit 110 has a function of detecting various kinds of information relating to user operation. For example, the sensor unit 110 can be implemented with an image sensor which senses a user as a target, a depth sensor, a microphone, or the like. Note that, in order to improve accuracy of detection of the line of sight, the sensor unit 110 regarding gaze input is preferably provided at a position where an eye of the user can be sensed from the front, near the display apparatus 200 or at an HIVID, glasses, or the like. The sensor unit 110 outputs detected information to the control unit 140.

The communication unit 120 has a function of transmitting/receiving data to/from other apparatuses. The communication unit 120 communicates with other apparatuses directly using a scheme such as, for example, a local area network (LAN), a wireless LAN, wireless fidelity (Wi-Fi, registered trademark), infrared communication and Bluetooth (registered trademark) or indirectly via a network access point, or the like. For example, the communication unit 120 receives information acquired by the operating apparatus 300 or transmits information indicating a display position of the indicator to the display apparatus 200.

The storage unit 130 records/reproduces data in/from a predetermined recording medium. For example, the storage unit 130 stores histories of information indicating correspondence relationship between the position of the indicator and the position of the gazing point.

The control unit 140, which functions as an arithmetic processing unit and a control apparatus, controls the whole operation within the information processing apparatus 100 in accordance with various kinds of programs. As illustrated in FIG. 2, the control unit 140 functions as a detecting unit 141, a storage control unit 143, a display control unit 145 and an estimating unit 147. The detecting unit 141 has a function of detecting information indicating user operation. The storage control unit 143 has a function of storing information indicating correspondence relationship between the position of the indicator and the position of the gazing point in the storage unit 130 and acquiring the information from the storage unit 130. The display control unit 145 has a function of controlling the display position of the indicator to be displayed at the display apparatus 200. The estimating unit 147 has a function of performing estimation based on a history of information indicating correspondence relationship between the position of the gazing point and the position of the indicator.

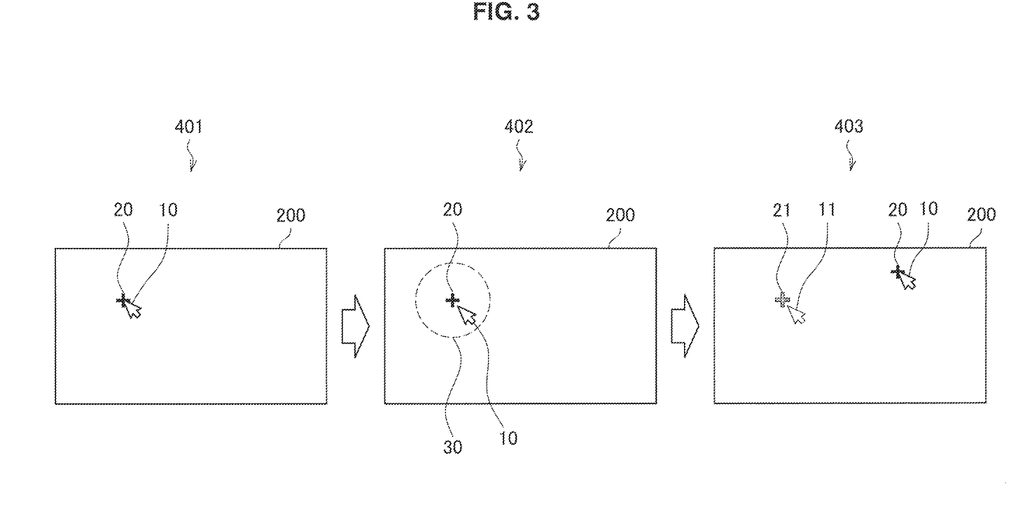

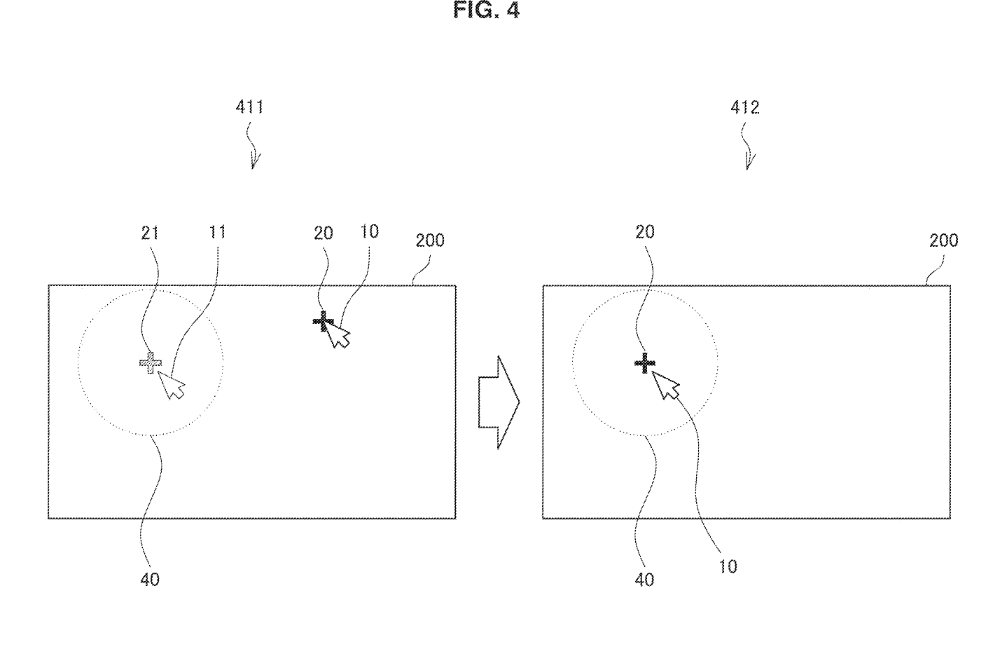

The configuration example of the information processing apparatus 100 according to the present embodiment has been described above. Technical characteristics of the information processing apparatus 100 according to the present embodiment will be described next with reference to FIG. 3 and FIG. 4.

### 3. TECHNICAL CHARACTERISTICS

### <3.1. Operation Information Acquisition Function>

The information processing apparatus 100 (for example, the detecting unit 141) according to the present embodiment has a function of acquiring information indicating user operation.

Here, the information indicating user operation includes information indicating an instruction for moving the indicator, information indicating an instruction for selecting a display object, information indicating an instruction for displaying menu, or the like. Hereinafter, the information indicating user operation will be also referred to as operation information.

For example, the detecting unit 141 may detect operation information on the basis of information detected by the sensor unit 110. Specifically, the detecting unit 141 may detect operation information regarding gaze input, such as a position of a gazing point and a moving direction and speed of the line of sight by recognizing the position of an eye of the user and the direction of the line of sight on the basis of image information and depth information. Further, the detecting unit 141 may detect operation information regarding gesture input by recognizing user gesture on the basis of image information and depth information. Still further, the detecting unit 141 may detect operation information regarding voice input by recognizing user voice on the basis of voice information.

For example, the detecting unit 141 may detect operation information on the basis of information received from the operating apparatus 300 by the communication unit 120. Specifically, the detecting unit 141 may acquire operation information regarding touch input, mouse input or keyboard input on the basis of information indicating touch to a touch pad, movement of a mouse or depression of a key of a keyboard.

### <3.2. Multimodal Interface Function>

The information processing apparatus 100 (for example, the display control unit 145) according to the present embodiment has a function of providing multimodal interface. For example, the display control unit 145 controls a display position of the indicator on the basis of operation information of various kinds of modals. Here, gaze input will be particularly described.

For example, the display control unit 145 controls the display position of the indicator using gaze input. Note that control of the display position of the indicator using gaze input is control of the display position based on operation information regarding gaze input. Specifically, the display control unit 145 controls the display position of the indicator using a position of a gazing point. The gazing point is a point the user gazes at, and, for example, an arbitrary point on a display surface of the display apparatus 200. For example, the display control unit 145 displays the indicator at the position of the gazing point. Because there can be a case where an error occurs between the position of the gazing point and a position where the user actually desires to set the indicator, the display control unit 145 may correct the position of the indicator at a position appropriately displaced from the position of the gazing point while taking into account this error. In this manner, control of the display position of the indicator using gaze input is realized.

Note that the position of the gazing point can be regarded as a focused position. For example, concerning a display, or the like, a position on a display surface is the position of the gazing point. Meanwhile, concerning an apparatus such as an HMD, which displays a virtual object on a lens having permeability while the virtual object is superimposed in real space, not a position on the lens but a position in real space on which the virtual object is actually superimposed becomes the position of the gazing point. The same also applies to a case where a virtual object is displayed while the virtual object is superimposed in virtual space.

The user can perform operation while switching a modal to an appropriate modal from a plurality of modals using the multimodal interface function. For example, the user can perform operation while switching a modal, for example, can perform operation involving a large amount of movement in a large screen or across a plurality of screens using gaze input, and perform subsequent minute operation using touch input, or the like. Further, in the case were an error occurs between the position of the gazing point and a position where the user actually desires to perform operation, the user can adjust the error using other modals.

### <3.3. Input Restriction Function>

The information processing apparatus 100 (for example, the display control unit 145) according to the present embodiment has a function of appropriately restricting control of the display position of the indicator using gaze input.

For example, the display control unit 145 controls whether or not to control the display position of the indicator using gaze input in accordance with whether or not a difference between the position of the indicator operated by the user and the position of the gazing point of the user exceeds a threshold. For example, the display control unit 145 controls the display position of the indicator using gaze input (enables gaze input) in the case where the difference exceeds the threshold, while does not control the display position of the indicator using gaze input (disables gaze input) in the case where the difference does not exceed the threshold. By gaze input being restricted in a range where the difference does not exceed the threshold in this manner, it is possible to avoid movement of the indicator due to minute wobble of the line of sight. As a specific method for input restriction, the display control unit 145 may set a region in which a difference from the position of the gazing point falls within a range of the threshold and may disable gaze input in the case where the indicator is located within the region, while enabling gaze input in the case where the indicator is located outside the region. As another method, the display control unit 145 may set a region in which a difference from the position of the indicator falls within a range of the threshold and may disable gaze input in the case where the gazing point is located within the region, while enabling gaze input in the case where the gazing point is located outside the region. In the present specification, description will be provided assuming that the former method is employed as an example. Further, a region where a difference from the gazing point falls within the range of the threshold will be also referred to as a gazing region.

### <3.4. Correspondence Relationship Storage Function>

The information processing apparatus 100 (for example, the storage control unit 143) according to the present embodiment has a function of storing information indicating correspondence relationship between the position of the gazing point of the user and the position of the indicator operated by the user.

For example, the storage control unit 143 stores information indicating correspondence relationship between the position of the gazing point and the position of the indicator in the storage unit 130. This information indicating the correspondence relationship will be, hereinafter, also referred to as correspondence relationship information. The correspondence relationship information includes, for example, information of the positions of the gazing point and the indicator. By the storage control unit 143 storing the correspondence relationship information, a display control function using a history of the correspondence relationship information which will be described later is realized. For example, in the case where the user adjusts an error between the position of the gazing point and a position where the user actually desires to set the indicator using other modals, the position of the gazing point is displaced from the position of the indicator. The information processing apparatus 100 stores this adjustment result as the correspondence relationship information and reproduces the adjustment using a display control function using the history of the correspondence relationship information. By this means, because the user can omit to perform adjustment again, convenience is improved. Note that the position of the gazing point can be detected by the detecting unit 141, and the position of the indicator can be acquired by the display control unit 145 which controls the indicator.

For example, the storage control unit 143 controls whether or not to store the correspondence relationship information in the storage unit 130 in accordance with whether or not a difference between the position of the indicator and the position of the gazing point exceeds a threshold (second threshold). For example, the storage control unit 143 stores the correspondence relationship information in the case where the difference exceeds the threshold, while does not store the correspondence relationship information in the case where the difference does not exceed the threshold. By this means, the information processing apparatus 100 can store the correspondence relationship information after an error between the position of the gazing point and a position where the user actually desires to set the indicator is adjusted at a timing at which the indicator follows movement of the line of sight which is not intended to be used for moving the indicator. Note that the threshold in the present function may be identical with or different from the threshold used in the above-described input restriction function. In the present specification, description will be provided assuming that these thresholds are identical. Here, a specific example of the present function will be described in detail with reference to FIG. 3.

FIG. 3 is a diagram for explaining the correspondence relationship information storage function of the information processing apparatus 100 according to the present embodiment. As indicated with reference numeral 401, the display apparatus 200 displays the indicator 10 at the position of a gazing point 20. In the case where an error occurs between the position of the gazing point 20 and the position where the user actually desires to set the indicator 10, as indicated with reference numeral 402, the user adjusts the position of the indicator 10 at a position displaced from the gazing point 20 using other modals. Here, the information processing apparatus 100 may disable gaze input and maintain the position of the indicator 10 using the above-described input restriction function even if the gazing point 20 moves in the case where the indicator 10 is located within a gazing region 30. Then, as indicated with reference numeral 403, in the case where the position of the gazing point 20 largely moves, and the position of the indicator 10 goes outside the gazing region 30, the information processing apparatus 100 enables gaze input and displays the indicator 10 at the position of the gazing point 20. In this event, the information processing apparatus 100 may store information indicating correspondence relationship between a position of a past indicator 11 and a position of a past gazing point 21, corresponding to the indicator 10 and the gazing point 20 in reference numeral 402. In another example, the information processing apparatus 100 may store information indicating correspondence relationship between the position of the indicator 10 and the position of the gazing point 20 at a timing at which the display position of the indicator 10 is adjusted by the user. Note that the gazing point 20 and the gazing region 30, and the past indicator 11 and the past gazing point 21 are not displayed.

The correspondence relationship information can include various kinds of information in addition to the information indicating the position of the gazing point and the position of the indicator.

For example, the correspondence relationship information may include information indicating content displayed at a time point at which the information indicating the position of the gazing point or the position of the indicator is detected. For example, the storage control unit 143 stores correspondence relationship information including information indicating content displayed at a time point at which the position of the gazing point is detected by the detecting unit 141 or at a time point at which information indicating the position of the indicator is acquired by the display control unit 145. In the example illustrated in FIG. 3, the storage control unit 143 stores correspondence relationship information, for example, including information indicating content displayed at the display apparatus 200 at a time point indicated with reference numeral 402.

For example, the correspondence relationship information may include information indicating accuracy of detection of the position of the gazing point at a time point at which information indicating the position of the gazing point is detected. For example, the storage control unit 143 stores correspondence relationship information, for example, including information indicating accuracy of detection of the line of sight at a time point indicated with reference numeral 402 in FIG. 3. The information indicating accuracy of detection of the line of sight may include, for example, information indicating resolution of an image sensor included in a sensor unit 110, or the like. Further, because, typically, accuracy of detection of the line of sight is improved as a distance between the sensor and the user is shorter, the information indicating accuracy of detection of the line of sight may include information indicating a distance between the sensor unit 110 and the user.

For example, the correspondence relationship information may include information indicating time at which correspondence relationship between the position of the gazing point and the position of the indicator is acquired. For example, the storage control unit 143 stores correspondence relationship information, for example, including information indicating time indicated with reference numeral 402 in FIG. 3.

For example, the correspondence relationship information may include information for identifying a target user. For example, the storage control unit 143 stores correspondence relationship information including information indicating a facial recognition result of the user, or the like.

### <3.5. Display Control Function Using History of Correspondence Relationship Information>

The information processing apparatus 100 (for example, the storage control unit 143 and the display control unit 145) according to the present embodiment has a function of controlling the display position of the indicator using a history of the correspondence relationship information stored in the storage unit 130.

For example, the storage control unit 143 acquires a history of the correspondence relationship information from the storage unit 130. The display control unit 145 then controls the display position of the indicator so that the indicator is displayed at a position corresponding to a position of a gazing point at present on the basis of the acquired history of the correspondence relationship information. For example, the display control unit 145 corrects the display position of the indicator so that positional relationship between the position of the gazing point and the position of the indicator is reproduced when the user adjusts an error between the position of the gazing point and the position where the user actually desires to set the indicator in the past. By this means, the user can omit to perform adjustment again, so that convenience is improved.

The display control unit 145 may determine whether or not to control the display position of the indicator on the basis of a history of the correspondence relationship information in accordance with whether or not a difference between the position of the gazing point at present and the position of the past gazing point in the history of the correspondence relationship information exceeds a threshold (first threshold). For example, the display control unit 145 determines to correct the display position of the indicator on the basis of the history of the correspondence relationship in the case where the difference exceeds the threshold and determines not to correct the display position on the basis of the history of the correspondence relationship information in the case where the difference does not exceed the threshold. By this means, in the case where a gazing point at present moves to a position where a distance from the position of the past gazing point is within a threshold, the display position of the indicator is corrected on the basis of the history of the correspondence relationship information. Note that a magnitude of the threshold may be different for each history of the correspondence relationship information. Hereinafter, a region where a difference from the position of the past gazing point in the history of the correspondence relationship information falls within a range of a threshold will be also referred to as an active region. Further, a distance between the position of the gazing point and the position of the indicator, caused by correction will be also referred to as a correction amount. Note that the display control unit 145 may determine whether or not to control the display position of the indicator on the basis of the history of the correspondence relationship information in accordance with whether or not a difference between the position of the gazing point at present and the position of the past indicator in the history of the correspondence relationship information exceeds a threshold.

The value of the threshold can be set using various methods. For example, the display control unit 145 may set the first threshold in accordance with a magnitude of a difference between the position of the past indicator and the position of the past gazing point in the history of the correspondence relationship information. For example, the display control unit 145 may set a larger active region for a history of the correspondence relationship information in which an error between the position of the past indicator and the position of the past gazing point is larger, while setting a smaller active region for a history of the correspondence relationship information in which the error is smaller. According to such a setting method, it is possible to set more regions as active regions in a region where an error on the display surface is large than in a region where the error is small. Further, the display control unit 145 may set an active region whose radius is a distance obtained by multiplying a distance between the position of the past gazing point and the position of the past indicator by a number exceeding 1. According to such a setting method, it is possible to set more regions on the display surface as active regions.

Further, there can be various methods for controlling the display position of the indicator.

For example, the display control unit 145 may display the indicator at the position of the past indicator in the history of the correspondence relationship information. For example, the display control unit 145 extracts a history of correspondence relationship information in which a position of a gazing point at present is included in an active region and displays an indicator at present at a position of a past indicator in the extracted correspondence relationship information. By this means, an absolute position of the past indicator is reproduced.

For example, the display control unit 145 may display the indicator at the position where relative positional relationship between the past gazing point and the past indicator in the history of the correspondence relationship information is reflected on a position of a gazing point at present detected by the detecting unit 141. For example, the display control unit 145 extracts a history of the correspondence relationship information in which the position of the gazing point at present is included in an active region and displays an indicator at present at a position obtained by adding a relative position of the indicator based on the position of the past gazing point in the extracted correspondence relationship information to the position of the gazing point at present. By this means, relative positional relationship between the past gazing point and the past indicator is reproduced.

Here, the present function will be described in detail with reference to FIG. 4 using a specific example.

FIG. 4 is a diagram for explaining a display control function using a history of correspondence relationship information of the information processing apparatus 100 according to the present embodiment. As indicated with reference numeral 411, the display apparatus 200 displays the indicator 10 at the position of the gazing point 20. In reference numeral 411, a past indicator 11, a past gazing point 21 and an active region 40 relating to the past gazing point 21 in a history of certain correspondence relationship information are respectively illustrated. It is assumed that the past indicator 11, the past gazing point 21 and the active region 40 are not displayed. As indicated with reference numeral 412, in the case where the position of the gazing point 20 moves and enters the active region 40, the display apparatus 200 displays the indicator 10 at a position corresponding to positional relationship between the past indicator 11 and the past gazing point 21. In this event, an absolute position of the past indicator 11 may be reproduced, or relative positional relationship between the past gazing point 21 and the past indicator 11 may be reproduced.

The display control unit 145 can select a history of correspondence relationship information to be used for controlling the display position of the indicator from histories of the correspondence relationship information using various standards.

For example, the display control unit 145 may control the display position of the indicator on the basis of a history of correspondence relationship information corresponding to content displayed at present. For example, the display control unit 145 uses a history of correspondence relationship information detected and stored when content identical with or similar to content displayed at present at the display apparatus 200 is displayed. By this means, for example, in the case where tendency of an error between the position of the gazing point and the position where the user actually desires to set the indicator is different for each application, the information processing apparatus 100 can correct the display position in accordance with this tendency. Note that the display control unit 145 may perform adjustment such as expanding or reducing an active region and increasing or reducing a correction amount, in accordance with a difference between present content and past content.

For example, the display control unit 145 may control the display position of the indicator on the basis of a history of correspondence relationship information corresponding to accuracy of detection of the position of the gazing point at present. For example, the display control unit 145 uses a history of correspondence relationship information detected and stored when accuracy of detection of the line of sight is the same as or close to accuracy of detection of the line of sight at present. Specifically, the display control unit 145 uses a history of correspondence relationship information in which resolution of an image sensor is the same as resolution at present or falls within a threshold and a distance between the sensor unit 110 and the user is the same as a distance at present or falls within a threshold. By this means, the information processing apparatus 100 can provide stable operability. Note that the display control unit 145 may perform adjustment such as expanding or reducing an active region and increasing or reducing a correction amount in accordance with a difference between present accuracy of detection of the line of sight and past accuracy of detection of the line of sight.

For example, the display control unit 145 may control the display position of the indicator on the basis of a history of correspondence relationship information in which the position of the past gazing point in the history of the correspondence relationship information is the closest to the position of the gazing point at present. For example, the display control unit 145 uses a history of correspondence relationship information in which the past gazing point is located at a position closer to the position of the gazing point at present in the case where a plurality of active regions overlap. By this means, the information processing apparatus 100 can select a more appropriate history of correspondence relationship information from a plurality of histories of correspondence relationship information.

For example, the display control unit 145 may control the display position of the indicator on the basis of a history of correspondence relationship information with a shorter elapsed time since the information is acquired. By this means, the information processing apparatus 100 can reproduce positional relationship in a history of the later correspondence relationship information.

For example, the display control unit 145 may control the display position of the indicator on the basis of a history of correspondence relationship information acquired for a target user. By this means, the information processing apparatus 100 can reproduce positional relationship using a history of correspondence relationship information different for each user.

### <3.6. Calibration Function>

The information processing apparatus 100 (for example, the display control unit 145 and the estimating unit 147) according to the present embodiment has a function of performing calibration relating to detection of the line of sight.

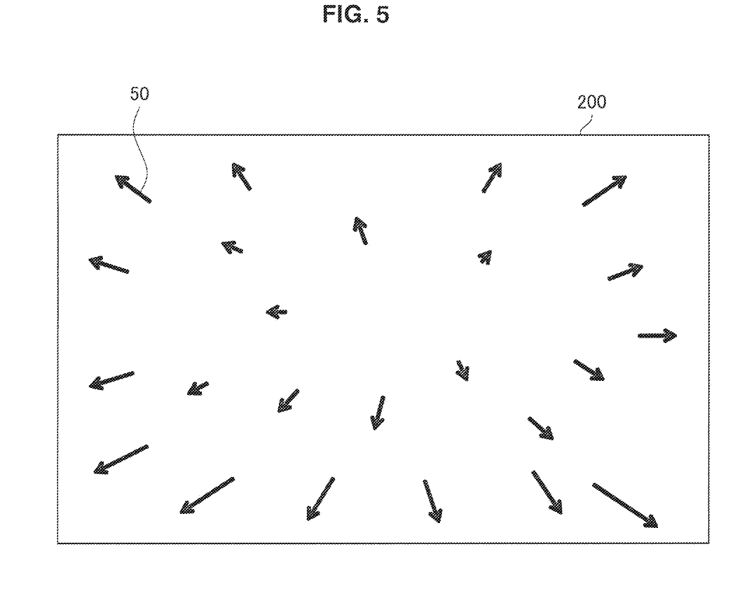

The information processing apparatus 100 accumulates information indicating an error between the position of the gazing point and the position where the user actually desires to set the indicator using the above-described correspondence relationship information storage function. Therefore, the detecting unit 141 may output a detection result at the detected position of the gazing point assuming that a position where the error is taken into account is a correct gazing point. In this manner, calibration relating to detection of the line of sight is realized. The present function will be described in detail below with reference to FIG. 5 using a specific example.

FIG. 5 is a diagram illustrating an example of a map for calibration relating to detection of the line of sight. Arrows included in FIG. 5 respectively indicate content of calibration on the display surface of the display apparatus 200. A starting point of the arrow 50 corresponds to the position of the gazing point detected in the past, and an end point corresponds to a position where the user actually desires to set the indicator in the past. Therefore, the detecting unit 141 outputs the position of the end point as the detection result of the gazing point in the case where the detected position of the gazing point at present matches one of the original points of the arrows 50 illustrated in FIG. 5.

However, the position of the gazing point at present does not always match the position of the past gazing point. Therefore, the estimating unit 147 may estimate correspondence relationship information which is not included in histories on the basis of a history of the correspondence relationship information. For example, the estimating unit 147 may estimate correspondence relationship information relating to the position of the gazing point at present by averaging differences or performing weighted average, or the like, on differences between the positions of the gazing points and the positions of the indicators in histories of correspondence relationship information relating to gazing points located around the position of the gazing point at present in the past. By this means, the information processing apparatus 100 can perform calibration in accordance with tendency of a surrounding error even in the case where a history of correspondence relationship information in which the position of the gazing point matches the position of the gazing point at present is not stored in the storage unit 130.

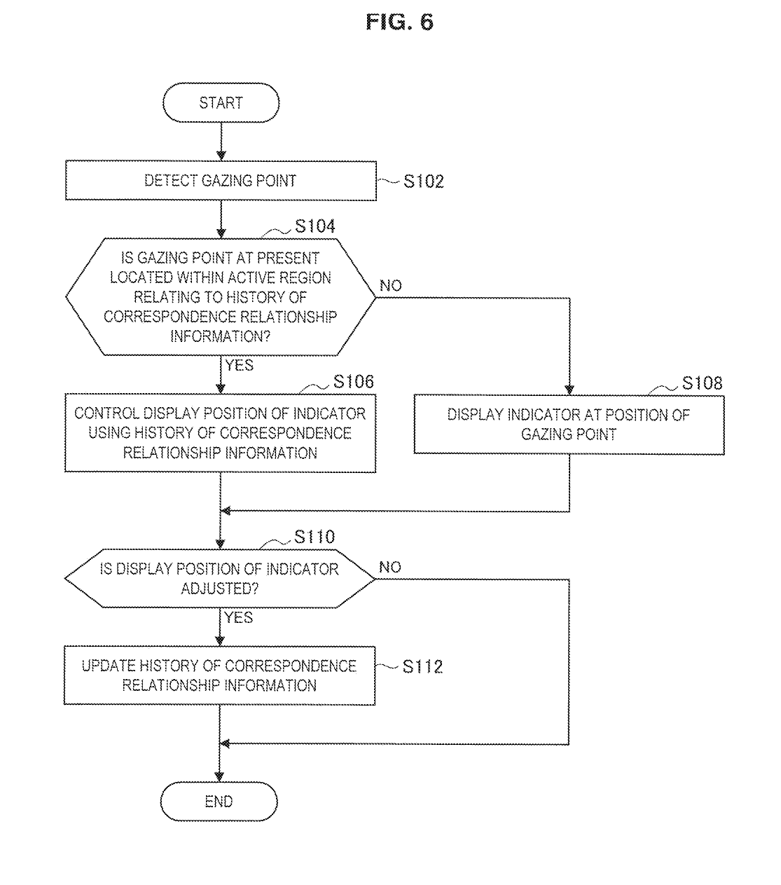

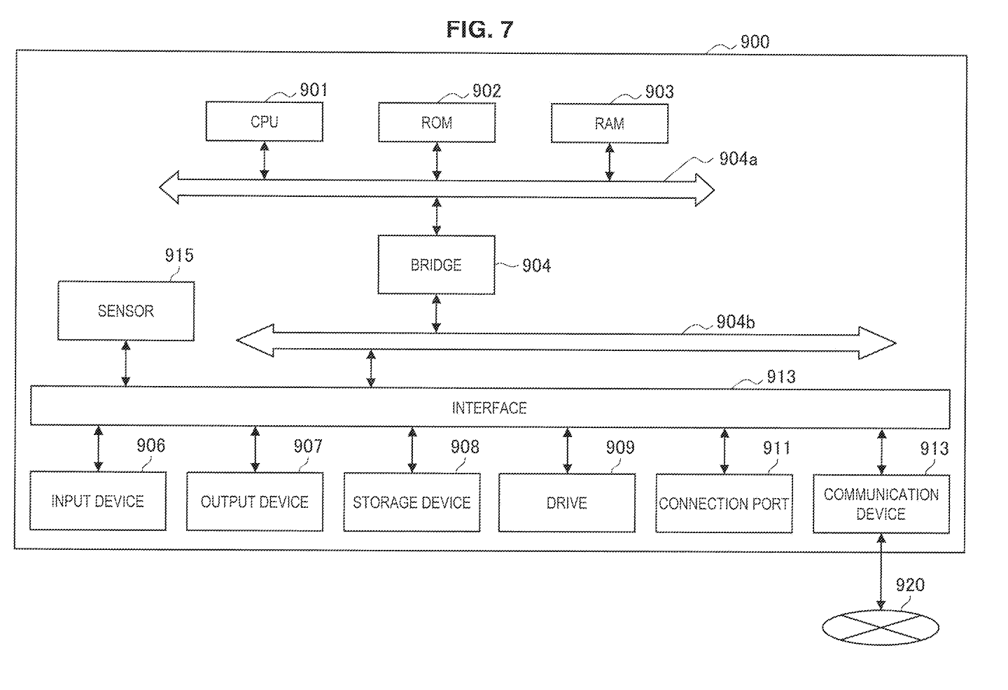

The technical characteristics of the information processing apparatus 100 according to the present embodiment have been described above. An operation processing example of the information processing apparatus 100 according to the present embodiment will be described next with reference to FIGS. 6 and 7.

### 4. OPERATION PROCESSING EXAMPLE

FIG. 6 is a flowchart illustrating an example of flow of indicator display position control processing executed at the information processing apparatus 100 according to the present embodiment.

As illustrated in FIG. 6, first, the detecting unit 141 detects a gazing point (step S102). Then, the display control unit 145 determines whether or not a gazing point at present is located within an active region relating to a history of correspondence relationship information (step S104). In the case where the gazing point at present is located within the range (step S104: Yes), the display control unit 145 controls the display position of the indicator using the history of correspondence relationship information (step S106). On the other hand, in the case where the gazing point at present is located outside the range (step S104: No), the display control unit 145 displays the indicator at the position of the gazing point (step S108).

Subsequently, the display control unit 145 determines whether or not the display position of the indicator is adjusted by the user using other modals (step S110). In the case where it is determined that the display position is adjusted (step S110: Yes), the storage control unit 143 updates the history of correspondence relationship information stored in the storage unit 130 by storing information indicating correspondence relationship between the position of the gazing point and the position of the indicator after adjustment (step S112). In this event, a history of old correspondence relationship information may be deleted or may be averaged with newly stored correspondence relationship information. Then, the processing ends. On the other hand, in the case where it is determined that the display position is not adjusted (step S110: No), the processing ends.

The operation processing example of the information processing apparatus 100 according to the present embodiment has been described above.

### 5. EXAMPLE OF HARDWARE CONFIGURATION

Finally, a hardware configuration of an information processing apparatus according to the present embodiment will be described with reference to FIG. 7. FIG. 7 is a block diagram illustrating an example of the hardware configuration of the information processing apparatus according to the present embodiment. Meanwhile, the information processing apparatus 900 illustrated in FIG. 7 may realize the information processing apparatus 100 illustrated in FIG. 2, for example. Information processing by the information processing apparatus 100 according to the present embodiment is realized according to cooperation between software and hardware described below.

As illustrated in FIG. 7, the information processing apparatus 900 includes a central processing unit (CPU) 901, a read only memory (ROM) 902, a random access memory (RAM) 903 and a host bus 904a. In addition, the information processing apparatus 900 includes a bridge 904, an external bus 904b, an interface 905, an input device 906, an output device 907, a storage device 908, a drive 909, a connection port 911, a communication device 913 and a sensor 915. The information processing apparatus 900 may include a processing circuit such as a DSP or an ASIC instead of the CPU 901 or along therewith.

The CPU 901 functions as an arithmetic processing device and a control device and controls the overall operation in the information processing apparatus 900 according to various programs. Further, the CPU 901 may be a microprocessor. The ROM 902 stores programs used by the CPU 901, operation parameters and the like. The RAM 903 temporarily stores programs used in execution of the CPU 901, parameters appropriately changed in the execution, and the like. The CPU 901 may form the controller 140 illustrated in FIG. 2, for example.

The CPU 901, the ROM 902 and the RAM 903 are connected by the host bus 904a including a CPU bus and the like. The host bus 904a is connected with the external bus 904b such as a peripheral component interconnect/interface (PCI) bus via the bridge 904. Further, the host bus 904a, the bridge 904 and the external bus 904b are not necessarily separately configured and such functions may be mounted in a single bus.

The input device 906 is realized by a device through which a user inputs information, for example, a mouse, a keyboard, a touch panel, a button, a microphone, a switch, a lever of the like. In addition, the input device 906 may be a remote control device using infrared ray or other electric waves or external connection equipment such as a cellular phone or a PDA corresponding to manipulation of the information processing apparatus 900, for example. Furthermore, the input device 906 may include an input control circuit or the like which generates an input signal on the basis of information input by the user using the aforementioned input means and outputs the input signal to the CPU 901, for example. The user of the information processing apparatus 900 may input various types of data or order a processing operation for the information processing apparatus 900 by manipulating the input device 906.

The output device 907 is formed by a device that may visually or aurally notify the user of acquired information. As such devices, there is a display device such as a CRT display device, a liquid crystal display device, a plasma display device, an EL display device, a laser projector, a LED projector or a lamp, a sound output device such as a speaker and a headphone, a printer device and the like. The output device 907 outputs results acquired through various processes performed by the information processing apparatus 900, for example. Specifically, the display device visually displays results acquired through various processes performed by the information processing apparatus 900 in various forms such as text, images, tables and graphs. On the other hand, the sound output device converts audio signals composed of reproduced sound data, audio data and the like into analog signals and aurally outputs the analog signals.

The storage device 908 is a device for data storage, formed as an example of a storage unit of the information processing apparatus 900. For example, the storage device 908 is realized by a magnetic storage device such as an HDD, a semiconductor storage device, an optical storage device, a magneto-optical storage device or the like. The storage device 908 may include a storage medium, a recording medium recording data on the storage medium, a reading device for reading data from the storage medium, a deletion device for deleting data recorded on the storage medium and the like. The storage device 908 stores programs and various types of data executed by the CPU 901, various types of data acquired from the outside and the like. The storage device 908 may form the storage unit 130 illustrated in FIG. 2, for example.

The drive 909 is a reader/writer for storage media and is included in or externally attached to the information processing apparatus 900. The drive 909 reads information recorded on a removable storage medium such as a magnetic disc, an optical disc, a magneto-optical disc or a semiconductor memory mounted thereon and outputs the information to the RAM 903. In addition, the drive 909 can write information on the removable storage medium.

The connection port 911 is an interface connected with external equipment and is a connector to the external equipment through which data may be transmitted through a universal serial bus (USB) and the like, for example.

The communication device 913 is a communication interface formed by a communication device for connection to a network 920 or the like, for example. The communication device 913 is a communication card or the like for a wired or wireless local area network (LAN), long term evolution (LTE), Bluetooth (registered trademark) or wireless USB (WUSB), for example. In addition, the communication device 913 may be a router for optical communication, a router for asymmetric digital subscriber line (ADSL), various communication modems or the like. For example, the communication device 913 may transmit/receive signals and the like to/from the Internet and other communication apparatuses according to a predetermined protocol, for example, TCP/IP or the like. The communication device 913 may form the communication unit 120 illustrated in FIG. 2, for example.

Further, the network 920 is a wired or wireless transmission path of information transmitted from devices connected to the network 920. For example, the network 920 may include a public circuit network such as the Internet, a telephone circuit network or a satellite communication network, various local area networks (LANs) including Ethernet (registered trademark), a wide area network (WAN) and the like. In addition, the network 920 may include a dedicated circuit network such as an internet protocol-virtual private network (IP-VPN).

The sensor 915 is various kinds of sensors such as, for example, a camera, a stereo camera, a time-of-flight (TOF) scheme distance sensor and a microphone. The sensor 915 acquires information indicating gesture or voice of the user, direction or movement of the line of sight of the user, or the like. The sensor 915 can, for example, constitute a sensor unit 110 illustrated in FIG. 2.

Hereinbefore, an example of a hardware configuration capable of realizing the functions of the information processing apparatus 900 according to this embodiment is shown. The respective components may be implemented using universal members, or may be implemented by hardware specific to the functions of the respective components. Accordingly, according to a technical level at the time when the embodiments are executed, it is possible to appropriately change hardware configurations to be used.

In addition, a computer program for realizing each of the functions of the information processing apparatus 900 according to the present embodiment may be created, and may be mounted in a PC or the like. Furthermore, a computer-readable recording medium on which such a computer program is stored may be provided. The recording medium is a magnetic disc, an optical disc, a magneto-optical disc, a flash memory, or the like, for example. The computer program may be delivered through a network, for example, without using the recording medium.

### 6. CONCLUSION

An embodiment of the present disclosure has been described in detail above with reference to FIG. 1 to FIG. 7. As described above, the information processing apparatus 100 according to the present embodiment displays the indicator at a position corresponding to the detected position of a gazing point at present of a user on the basis of a history of correspondence relationship information indicating correspondence relationship between the position of the gazing point of the user and the position of the indicator. For example, in the case where the user adjusts an error between the position of the gazing point and the position where the user actually desires to set the indicator using other modals, the information processing apparatus 100 stores the adjustment result as correspondence relationship information. The information processing apparatus 100 can then reproduce original positional relationship between the position of the gazing point and the position of the indicator on the basis of a history of the correspondence relationship information when the user moves the line of sight once and returns the line of sight to the original position. By this means, the user can omit to perform adjustment again, so that convenience relating to gaze input is improved.

Further, the information processing apparatus 100 according to the present embodiment can store/update the correspondence relationship information as needed. The information processing apparatus 100 accumulates correspondence relationship information for each location at which the user looks on the display surface of the display apparatus 200. While tendency of an error between the position of the gazing point and the position where the user actually desires to set the indicator can be different for each location on the display surface, the information processing apparatus 100 can correct the display position of the indicator in accordance with this tendency. Therefore, it is possible to improve accuracy of gaze input felt by the user.

The preferred embodiment of the present disclosure has been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, it is not necessary for the processing described in this specification with reference to the flowchart to be executed in the order shown in the flowchart. Some processing steps may be performed in parallel. Further, some of additional steps can be adopted, or some processing steps can be omitted.

Meanwhile, devices described in the specification may be realized as independents devices or part of or all devices may be realized as separate devices. For example, in the example of the functional configuration of the information processing apparatus 100 illustrated in FIG. 2, the storage unit 130 and the controller 140 may be included in a device such as a server connected to the sensor unit 110 and the communication unit 120 through a network or the like.

Further, each apparatus described in the present specification may be implemented as separate apparatuses or may be implemented as an integrally formed apparatus. For example, the information processing apparatus 100 and the display apparatus 200 may be integrally formed, or the information processing apparatus 100 and the operating apparatus 300 may be integrally formed.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing apparatus including:

a storage control unit configured to acquire, from a storage unit, a history of information indicating correspondence relationship between a position of a gazing point of a user and a position of an indicator indicating an operation position operated by the user;

a detecting unit configured to detect the position of the gazing point of the user; and

a display control unit configured to control a display position of the indicator so that the indicator is displayed at a position corresponding to the position of the gazing point at present detected by the detecting unit on the basis of the history of the information indicating the correspondence relationship acquired by the storage control unit.

(2)

The information processing apparatus according to (1),

in which the display control unit determines whether or not to control the display position of the indicator on the basis of the history of the information indicating the correspondence relationship, in accordance with whether or not a difference between the position of the gazing point at present and a position of the gazing point in the history of the information indicating the correspondence relationship exceeds a first threshold.

(3)

The information processing apparatus according to (2),

in which the display control unit sets the first threshold in accordance with a magnitude of a difference between the position of the indicator and the position of the gazing point in the history of the information indicating the correspondence relationship.

(4)

The information processing apparatus according to any one of (1) to (3),

in which the information indicating the correspondence relationship includes information indicating content displayed at a time point at which information indicating the position of the gazing point or the position of the indicator is detected, and

the display control unit controls the display position of the indicator on the basis of the history of the information indicating the correspondence relationship corresponding to content displayed at present.

(5)

The information processing apparatus according to any one of (1) to (4),

in which the information indicating the correspondence relationship includes information indicating accuracy of detection of the position of the gazing point at a time point at which information indicating the position of the gazing point is detected, and

the display control unit controls the display position of the indicator on the basis of the history of the information indicating the correspondence relationship corresponding to accuracy of detection of the position of the gazing point at present.

(6)

The information processing apparatus according to any one of (1) to (5),

in which the display control unit controls the display position of the indicator on the basis of the history of the information indicating the correspondence relationship in which the position of the gazing point in the history of the information indicating the correspondence relationship is the closest to the position of the gazing point at present.

(7)

The information processing apparatus according to any one of (1) to (6),

in which the display control unit controls the display position of the indicator on the basis of the history of the information indicating the correspondence relationship with a short elapsed time since the information is detected.

(8)

The information processing apparatus according to any one of (1) to (7),

in which the display control unit displays the indicator at a position of the indicator in the history of the information indicating the correspondence relationship.

(9)

The information processing apparatus according to any one of (1) to (7),

in which the display control unit displays the indicator at a position in which relative positional relationship between the gazing point and the indicator in the history of the information indicating the correspondence relationship is reflected on the position of the gazing point at present.

(10)

The information processing apparatus according to any one of (1) to (9), further including:

an estimating unit configured to estimate information indicating the correspondence relationship not included in a history, on the basis of the history of the information indicating the correspondence relationship.

(11)

The information processing apparatus according to any one of (1) to (10),

in which the storage control unit stores the information indicating the correspondence relationship in the storage unit.

(12)

The information processing apparatus according to (11),

in which the storage control unit controls whether or not to store the information indicating the correspondence relationship in the storage unit in accordance with whether or not a difference between the position of the indicator and the position of the gazing point exceeds a second threshold.

(13)

An information processing method executed by a processor, the method including:

acquiring, from a storage unit, a history of information indicating correspondence relationship between a position of a gazing point of a user and a position of an indicator indicating an operation position operated by the user;

detecting the position of the gazing point of the user; and

controlling a display position of the indicator so that the indicator is displayed at a position corresponding to the detected position of the gazing point at present on the basis of the acquired history of the information indicating the correspondence relationship.

(14)

A program causing a computer to function as:

a storage control unit configured to acquire, from a storage unit, a history of information indicating correspondence relationship between a position of a gazing point of a user and a position of an indicator indicating an operation position operated by the user;

a detecting unit configured to detect the position of the gazing point of the user; and

a display control unit configured to control a display position of the indicator so that the indicator is displayed at a position corresponding to the position of the gazing point at present detected by the detecting unit on the basis of the history of the information indicating the correspondence relationship acquired by the storage control unit.

### REFERENCE SIGNS LIST

1 information processing system
10 indicator
20 gazing point
30 gazing region
40 active region
100 information processing apparatus
110 sensor unit
120 communication unit
130 storage unit
140 control unit
141 detecting unit
143 storage control unit
145 display control unit
147 estimating unit
200 display apparatus
300 operating apparatus

1. An information processing apparatus comprising:
a storage control unit configured to acquire, from a storage unit, a history of information indicating correspondence relationship between a position of a gazing point of a user and a position of an indicator indicating an operation position operated by the user;
a detecting unit configured to detect the position of the gazing point of the user; and
a display control unit configured to control a display position of the indicator so that the indicator is displayed at a position corresponding to the position of the gazing point at present detected by the detecting unit on the basis of the history of the information indicating the correspondence relationship acquired by the storage control unit.

2. The information processing apparatus according to claim 1,
wherein the display control unit determines whether or not to control the display position of the indicator on the basis of the history of the information indicating the correspondence relationship, in accordance with whether or not a difference between the position of the gazing point at present and a position of the gazing point in the history of the information indicating the correspondence relationship exceeds a first threshold.

3. The information processing apparatus according to claim 2,
wherein the display control unit sets the first threshold in accordance with a magnitude of a difference between the position of the indicator and the position of the gazing point in the history of the information indicating the correspondence relationship.

4. The information processing apparatus according to claim 1,
wherein the information indicating the correspondence relationship includes information indicating content displayed at a time point at which information indicating the position of the gazing point or the position of the indicator is detected, and
the display control unit controls the display position of the indicator on the basis of the history of the information indicating the correspondence relationship corresponding to content displayed at present.

5. The information processing apparatus according to claim 1,
wherein the information indicating the correspondence relationship includes information indicating accuracy of detection of the position of the gazing point at a time point at which information indicating the position of the gazing point is detected, and
the display control unit controls the display position of the indicator on the basis of the history of the information indicating the correspondence relationship corresponding to accuracy of detection of the position of the gazing point at present.

6. The information processing apparatus according to claim 1,
wherein the display control unit controls the display position of the indicator on the basis of the history of the information indicating the correspondence relationship in which the position of the gazing point in the history of the information indicating the correspondence relationship is the closest to the position of the gazing point at present.

7. The information processing apparatus according to claim 1,
wherein the display control unit controls the display position of the indicator on the basis of the history of the information indicating the correspondence relationship with a short elapsed time since the information is detected.

8. The information processing apparatus according to claim 1,
wherein the display control unit displays the indicator at a position of the indicator in the history of the information indicating the correspondence relationship.

9. The information processing apparatus according to claim 1,
wherein the display control unit displays the indicator at a position in which relative positional relationship between the gazing point and the indicator in the history of the information indicating the correspondence relationship is reflected on the position of the gazing point at present.

10. The information processing apparatus according to claim 1, further comprising:
an estimating unit configured to estimate information indicating the correspondence relationship not included in a history, on the basis of the history of the information indicating the correspondence relationship.

11. The information processing apparatus according to claim 1,
wherein the storage control unit stores the information indicating the correspondence relationship in the storage unit.

12. The information processing apparatus according to claim 11,
wherein the storage control unit controls whether or not to store the information indicating the correspondence relationship in the storage unit in accordance with whether or not a difference between the position of the indicator and the position of the gazing point exceeds a second threshold.

13. An information processing method executed by a processor, the method comprising:
acquiring, from a storage unit, a history of information indicating correspondence relationship between a position of a gazing point of a user and a position of an indicator indicating an operation position operated by the user;
detecting the position of the gazing point of the user; and
controlling a display position of the indicator so that the indicator is displayed at a position corresponding to the detected position of the gazing point at present on the basis of the acquired history of the information indicating the correspondence relationship.

14. A program causing a computer to function as:
a storage control unit configured to acquire, from a storage unit, a history of information indicating correspondence relationship between a position of a gazing point of a user and a position of an indicator indicating an operation position operated by the user;
a detecting unit configured to detect the position of the gazing point of the user; and
a display control unit configured to control a display position of the indicator so that the indicator is displayed at a position corresponding to the position of the gazing point at present detected by the detecting unit on the basis of the history of the information indicating the correspondence relationship acquired by the storage control unit.
